(19) United States
(12) Patent Application Publication
(10) Pub. No.: US 2024/0427337 A1
(43) Pub. Date: Dec. 26, 2024

(54) SERVICING OF DELIVERY DRONES ON THE ROAD

(71) Applicant: International Business Machines Corporation, Armonk, NY (US)

(72) Inventor: Sarbajit K. Rakshit, Kolkata (IN)

(21) Appl. No.: 18/214,380

(22) Filed: Jun. 26, 2023

(51) Int. Cl. G05D 1/10; G05D 1/00

(52) U.S. Cl. CPC G05D 1/102

(57) ABSTRACT

A method of using a computing device to provide unmanned aerial vehicle (UAV) on road service including identifying a first UAV, traveling in a first direction, in need of service that requires down time for the first UAV less than a first threshold. A first road vehicle traveling in the first direction and having a landing area with an accommodation size for the first UAV and a second UAV is identified. Upon landing of the first UAV on the first road vehicle, a service request notification is sent to UAV service providers. The second UAV is landed on the first road vehicle next to the first UAV. The service for the first UAV is provided by the second UAV.

### BACKGROUND

The field of embodiments of the present invention relates to charging and servicing drones or unmanned aerial vehicles (UAVs) on the road.

Drones will be used for a future mode of delivering products directly to a customer's location. These drones will carry goods from a warehouse and for delivery to customers. Drones operate via batteries and have a limited operating capability. Therefore, delivery drones are limited from flying too long of distances to deliver goods to customers. Other drones may be used for other purposes, such as weather monitoring, agricultural purpose, surveying structures, security uses, etc.

### SUMMARY

Embodiments relate to charging and servicing delivery drones (or UAVs) on the road. One embodiment provides a method of using a computing device to provide UAV on road service including identifying a first UAV, traveling in a first direction, in need of service that requires down time for the first UAV less than a first threshold. A first road vehicle traveling in the first direction and having a landing area with an accommodation size for the first UAV and a second UAV is identified. Upon landing of the first UAV on the first road vehicle, a service request notification is sent to UAV service providers. The second UAV is landed on the first road vehicle next to the first UAV. The service for the first UAV is provided by the second UAV.

These and other features, aspects and advantages of the present embodiments will become understood with reference to the following description, appended claims and accompanying figures.

### BRIEF DESCRIPTION OF THE DRAWINGS

FIG. 1 illustrates road vehicles maintaining distance between one another and a chain of drones (or UAVs), according to one embodiment;

FIG. 2 illustrates a first drone (or UAV) needing service and a service drone (or UAV) that each landed on a road vehicle for servicing the first drone, according to one embodiment;

FIG. 3 illustrates a method for servicing a drone (or UAV) on a road vehicle by a service drone, according to one embodiment;

FIGS. 4A-C illustrate an example of a first drone (or UAV) needing service that lands on a road vehicle and a nearby service drone (or UAV) that also lands on the road vehicle to conduct servicing of the first drone, according to one embodiment;

FIG. 4D illustrates an example service drone (or UAV) with at least one robotic arm, according to an embodiment;

FIGS. 5A-D illustrate an example of a first drone (or UAV) being serviced by a service drone (or UAV), according to an embodiment;

FIG. 6 illustrates a process for servicing a drone (or UAV) by a service drone (or UAV) on a road vehicle, according to an embodiment; and

FIG. 7 illustrates an example computing environment utilized by one or more embodiments.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to charging and servicing delivery drones (or UAVs) on the road. One embodiment provides a method of using a computing device to provide UAV on road service including identifying a first UAV, traveling in a first direction, in need of service that requires down time for the first UAV less than a first threshold. A first road vehicle traveling in the first direction and having a landing area with an accommodation size for the first UAV and a second UAV is identified. Upon landing of the first UAV on the first road vehicle, a service request notification is sent to UAV service providers. The second UAV is landed on the first road vehicle next to the first UAV. The service for the first UAV is provided by the second UAV.

Drones (or UAVs) have limited battery capacity, and because of that it is not possible for a drone to travel for too long of a distance. If a drone performs short distance travel but for multiple trips, then at some point a drone battery needs to be recharged. It takes about 30 to 60 minutes to recharge a drone battery. Therefore, down time due to recharging a drone battery causes loss of productivity. During a drone flight, if the drone needs any repair or servicing, then the drone needs to land at the service provider for repair or service. In one or more embodiments, a method and system reduces or eliminates drone downtime due to battery recharging or maintenance/service, which maintains productivity of drone-based delivery.

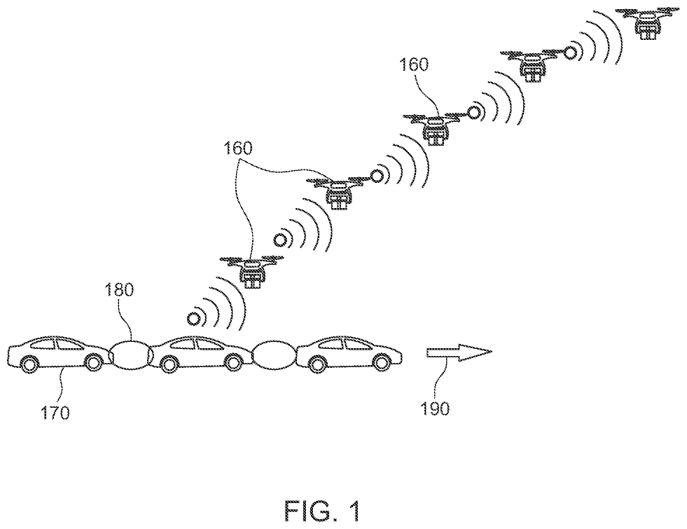

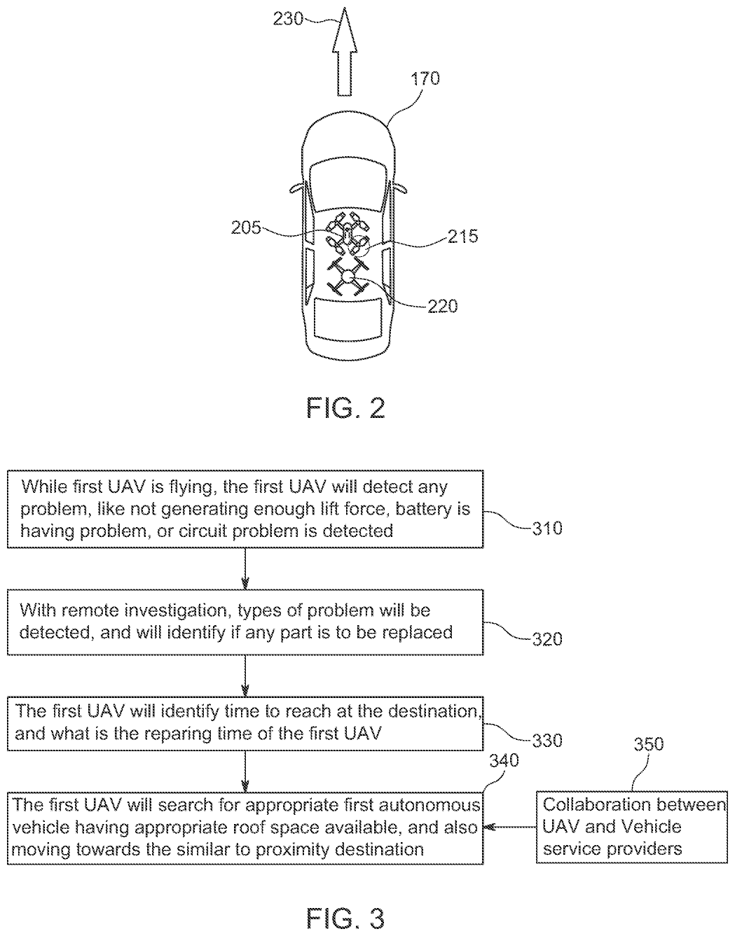

FIG. 1 illustrates road vehicles 170 maintaining distance 180 between one another and a chain of drones 160 (or UAVs), according to one embodiment. In one embodiment, the drones 160 and the road vehicles 170 (e.g., autonomous or non-autonomous cars, trucks, busses, etc.) heading in the same direction 190 collaborate with each other to provide wireless power transfer (e.g., inductive coupling, magnetic resonance, etc.) to charge the drones 160 batteries, and also for potential platforms to support repairing or servicing of a drone 160 without downtime due to wireless recharge or maintenance/service of the drones 160. To accomplish this, in one embodiment, a drone 160 may land on a road vehicle 170 (e.g., a roof, attached platform, etc.) together with a service drone 220 (FIG. 2) where the road vehicle 170 is heading in the same direction of the drone 160, where the drone 160 remains moving towards a delivery location. This assists the drone 160 to continue traveling in the direction 190 such that the drone 160 does not experience a delivery delay due to service or maintenance down time.

FIG. 2 illustrates a first drone 205 (or UAV) needing service and a service drone 220 (or UAV) that each landed on a road vehicle 170 for servicing the first drone 205, according to one embodiment. As shown, the first drone 205 has a service issue, such as a damaged blade 215. In one embodiment, due to the first drone 205 requiring service of the damaged blade 215, the first drone 205 lands on the road vehicle 170 that is heading in the direction 230, which is the same direction the first drone 205 is heading for delivery (or even a return to a warehouse or distribution center) to reduce or eliminate down time for the first drone 205. In one example embodiment, the service drone 220 receives a communication or message regarding the first drone 205 requesting service and flies towards the closest and available road vehicle 170 that is heading in the direction 230 and that also has enough landing space for the first drone 205 and the service drone 220. In some instances, the service drone 220 may already be positioned on a road vehicle 170 heading in the direction 230 so that the first drone just needs to meet on the landing location on the road vehicle 170.

In one embodiment, service arrangement for an identified type of problem with any first drone (or UAV) that needs service or maintenance that requires downtime (e.g., blade replacement, battery or any electrical part replacement, etc.) without exceeding a threshold limit of delay in arriving at the destination may be accomplished. The first drone identifies an appropriate first road vehicle (autonomous or non-autonomous) having requisite roof space area availability for conducting the service where the first road vehicle is traveling towards the proximity of the target destination of the first drone. The first road vehicle and the first drone collaborate with each other via communications (e.g., radio frequency (RF), etc.) and identify appropriate position on the landing zone (e.g., roof, platform on the vehicle, etc.) of the first road vehicle, such that one or more second drones that are able to perform servicing can land on the remaining portion of the available space on the first road vehicle.

In one embodiment, once the first drone lands on the first road vehicle, then either the first drone or the first road vehicle sends notification to drone service providers. Based on an identified problem, the service drone lands on the remaining portion of the first road vehicle. Different types of second service drones can already be present on the first road vehicle in different locations or can be present in any roadside static drone (or UAV) service providers location. Based on the relative position of the first drone, the devices in the system identify appropriate second drones or service drones that can provide the required service with optimum time. Based on the servicing need of any first drone, the first drone evaluates how long the first drone can fly in the current status condition, and accordingly can identify an appropriate option of landing between a second road vehicle used for servicing a second drone and is already available or on a first road vehicle having the requisite space to land a second drone or service drone for providing the service. Both the first drone having a problem and the robotic system of the service drone collaborate with each other to perform appropriate replacement of the parts or perform the required maintenance of the first drone.

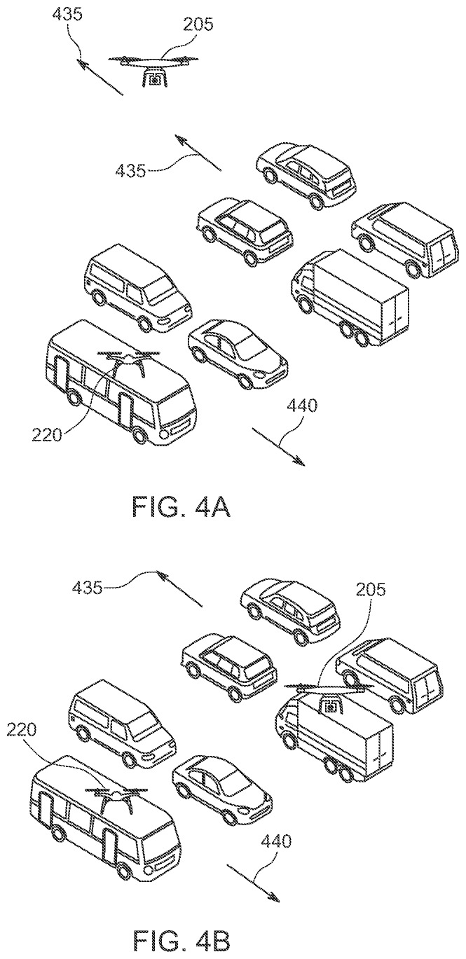

FIG. 3 illustrates a process for servicing a drone (or UAV) on a road vehicle by a service drone, according to one embodiment. In one embodiment, in block 310 while a first drone (or UAV) (e.g., drone 160, FIG. 1, first drone 205, FIG. 2, etc.) is flying, the first drone detects a problem, such as not generating enough lift force, battery problems (low battery charge, defective battery, etc.) or a circuit issue (damaged circuit board, receiver or transmitter issue, etc.). In block 320, with a remote investigation (e.g., by a drone service provider, etc.) of the drone problem, the issue is detected and any part(s) requiring maintenance, service or replacement is detected by a service provider, a service drone within service proximity of the drone, a service server, cloud-based service environment, etc. In block 330, the drone identifies a time to reach a delivery or target destination and the time it takes to service or repair the drone. In block 340, the drone searches for a first autonomous vehicle (e.g., a road vehicle) that has appropriate roof (or platform) space availability that is also heading to or in a similar proximate direction. The drone may conduct the search using communications, messaging, receipt of location coordinates (e.g., from a global position system (GPS) device onboard autonomous vehicles, collaboration information from other drones in communication with the drone, from a servicer or cloud-based platform, etc., from block 350). Once the information regarding the landing destination is determined, the drone and the service drone are programmed to land at the designated target location on the autonomous (or non-autonomous) vehicle and proceed to that landing location taking into consideration the location, speed and direction of the autonomous vehicle to coordinate a safe landing for both the drone and the service drone on the autonomous vehicle.

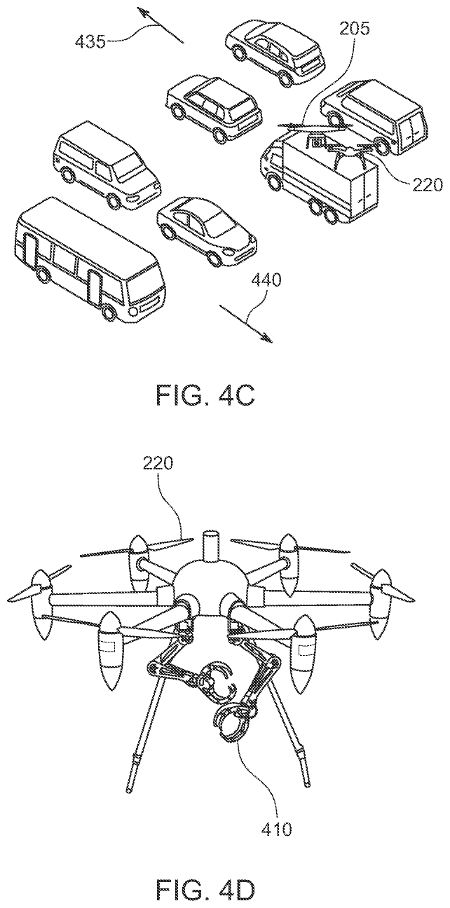

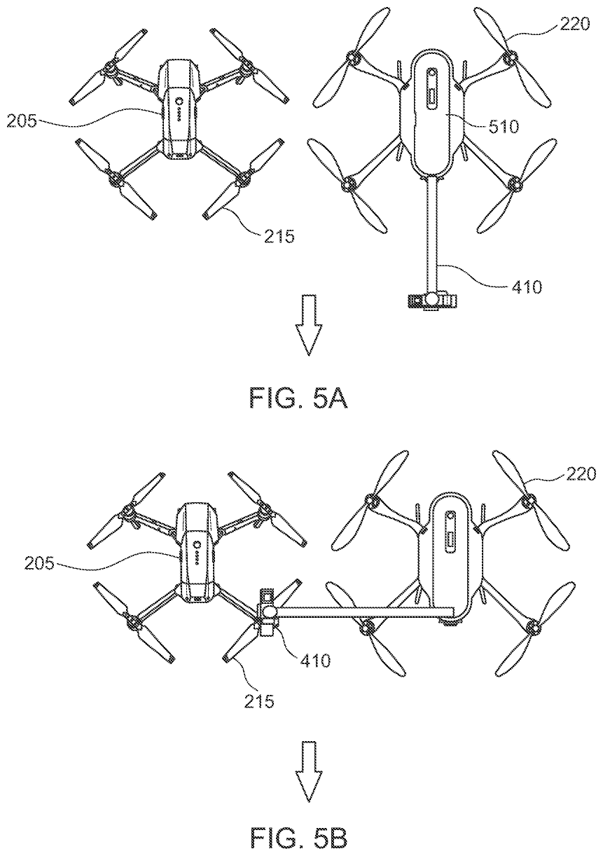

FIGS. 4A-C illustrate an example of a first drone 205 (or UAV) needing service that lands on a road vehicle and a nearby service drone 220 (or UAV) that also lands on the road vehicle to conduct servicing of the first drone 205, according to one embodiment. As shown in FIG. 4A, the first drone is traveling in the direction 435 and the service drone 220 is traveling on a road vehicle in the direction 440, which is opposite of the direction 435. In FIG. 4B the first drone 205 has identified a problem needing service and identifies a vehicle having enough landing space for the first drone 205 and also a service drone 220. The first drone 205 then proceeds to land on a road vehicle heading in the same direction 435. In FIG. 4C, the service drone 220 proceeds to head towards the road vehicle that the first drone 205 has already landed on. The service drone 220 then proceeds to land on the road vehicle to service the first drone 205. At this point, both the first drone 205 and the service drone 220 are both heading in the direction 305, which is the direction of the destination of the first drone 205.

FIG. 4D illustrates an example service drone 220 (or UAV) with at least one robotic arm 410, according to an embodiment. In one embodiment, the robotic arm(s) of the service drone 220 is telescopic, maneuverable and can also grip/hold/manipulate service parts in order to service a delivery drone (or UAV).

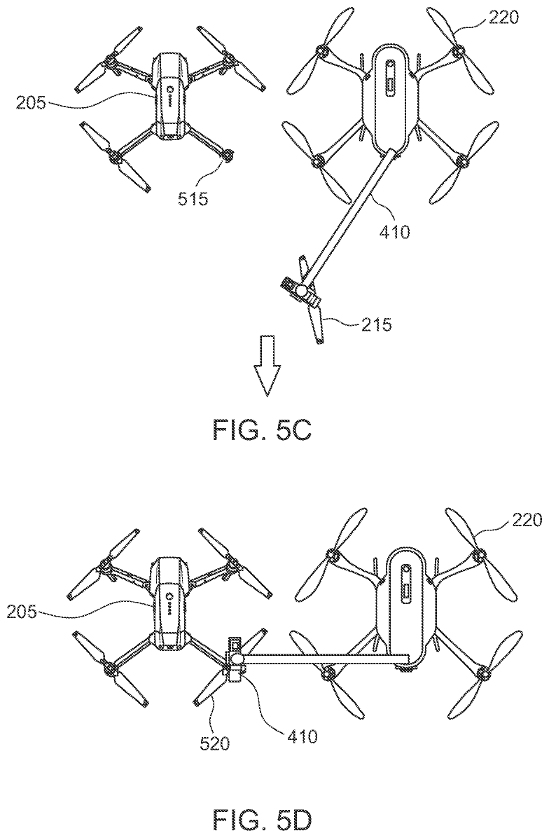

FIGS. 5A-D illustrate an example of a first drone 205 (or UAV) being serviced by a service drone 220 (or UAV), according to an embodiment. In one embodiment, the first drone 205 has a wireless power transfer circuitry such that the first drone 205 can receive and also can transfer power with a wireless power transfer mode. While the first drone 205 is traveling, the first drone 205 estimates the available current power status, and based on the payload and environmental parameters (e.g., wind, obstructions, flight path, weather, etc.) the system identifies the amount of distance that can be traveled by the drone 205. In one embodiment, the system identifies the remaining delivery distance needed to be traveled by the first drone 205, and whether the first drone 205 can complete the distance needed to reach the delivery destination. In one embodiment, the system identifies road vehicles that are running on the road by the system and identifies the direction of travel. The first drone 205 identifies which road vehicle can provide wireless power transfer to the first drone 205 traveling over the road. The first drone 205 and the road vehicle collaborate with each other to initiate power transfer such that the first drone 205 can land on the road vehicle. The first drone 205 lands on the road vehicle and is wirelessly recharged. When the road vehicle moves towards a different direction from the destination delivery location, the first drone 205 takes off from that road vehicle. The first drone 205 being recharged from the road vehicle, and is tracked using blockchain technology for determining how much power was transferred to the first drone 205. The first drone 205 identifies if any drone parts need to be repaired, and then communicates this information to drone-based service providers. The first drone 205 identifies which vehicle is traveling towards the destination location, and lands on that road vehicle. The service drone 220 also lands on the same road vehicle while the road vehicle is driving towards the direction of the delivery destination.

In FIG. 5A, in one embodiment the service drone 220 includes a robotic arm 410 and a spare parts storage chamber 510 and commences the required service of the first drone 205. The service drone 220 receives the type of service/repair needed to be performed and takes the appropriate action. In one example embodiment, the first drone 205 has a problem with the blade 215. In FIG. 5B, the service drone 220 uses the robotic arm 410 to remove the blade 215 from the first drone 205. In FIG. 5C, the robotic arm 410 has removed the blade 215 leaving the first drone 205 with an empty blade spindle 515. In FIG. 5D, the robotic arm 410 places a new blade 520 on the blade spindle 515 for repairing the first drone 205.

In one embodiment, the system identifies if multiple drones are to be recharged during its travel and if the drones can land on the road vehicle. These drones arrange themselves in a chain and create a continuous chain to connect to a traveling road vehicle moving towards the same direction as the drones. The drones create a wireless power transfer route with the traveling road vehicles and receive wireless power transferred from the vehicle. The system identifies which road vehicle has enough power and then can transfer power to a drone in need of a recharge. In one embodiment, the system identifies the speed of the road vehicle from communications and also the speed of the drones in the system as they collaborate with one another. The chain of drones create a wireless power transfer route from one drone to another, such that seamless power is transferred to the drones. The road vehicles maintain a proper distance with each other so that the road vehicles can seamlessly transfer power to the chain of drones. The system utilizes blockchain technology to calculate which road vehicle has transferred how much power to one or more drones, or provides a supporting platform to perform repair of a drone in need of service. Accordingly, a service charge requiring payment based on the service required, amount of charge needed, cost of parts, etc., is calculated by the system. A request for payment would be sent and payment would be transferred to the correct account in order for the service to be completed.

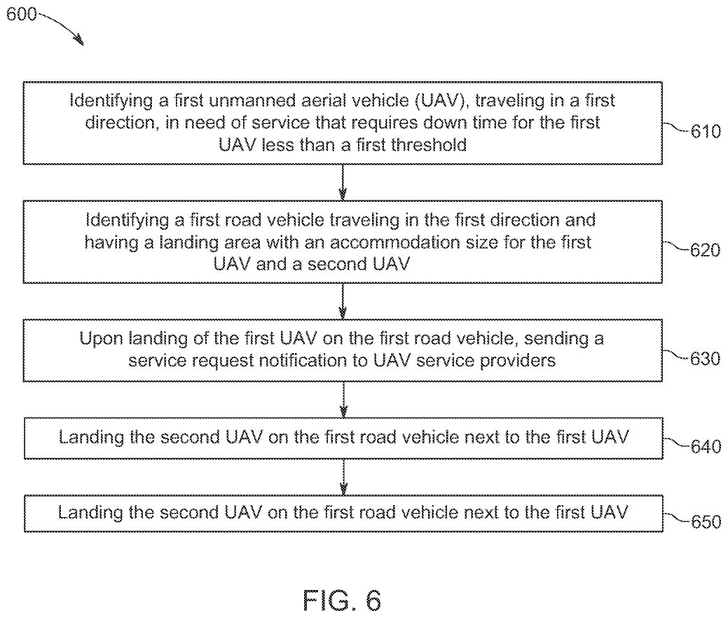

FIG. 6 illustrates a process 600 for servicing a drone (or UAV) by a service drone (or UAV) on a road vehicle, according to an embodiment. In one embodiment, in block 610 process 600 identifies a first UAV (e.g., first drone 205, FIGS. 2, 4A-C, 5A-D), traveling in a first direction, in need of service that requires down time for the first UAV less than a first threshold (e.g., a threshold of delay time). In block 620, process 600 identifies a first road vehicle (e.g., road vehicle 170, FIGS. 1-2) traveling in the first direction and having a landing area with an accommodation size for the first UAV and a second UAV (e.g., a service drone 220, FIGS. 2, 4A-D, 5A-D). In block 630, process 600 provides for sending of a service request notification to UAV service providers upon landing of the first UAV on the first road vehicle. In block 640, process 600 lands the second UAV on the first road vehicle next to the first UAV. In block 650, process 600 provides the service for the first UAV by the second UAV (e.g., recharging one or more batteries, replacement of parts, removing debris from a blade or body, etc.).

In some embodiments, process 600 may include the feature where blockchain technology is utilized for wireless charging of the first UAV and other UAVs and for collaboration of information based on wireless communication.

In one or more embodiments, process 600 may further include the feature that the first UAV is a delivery UAV, and the second UAV is a service UAV for servicing the first UAV.

In some embodiments, process 600 may include the feature where the second UAV comprises at least one robotic arm and a storage chamber for spare UAV parts.

In one or more embodiments, process 600 may additionally include the feature that a lifecycle operator process orchestrates execution of the plurality of pre-defined machine learning tasks, pipelines and triggers that manage one or more machine learning model instances.

In some embodiments, process 600 may further include the feature that the second UAV is configured for replacement of first UAV parts that are in need of service by using the robotic arm.

In one or more embodiments, process 600 may include the feature that the first threshold is a delay time threshold, the first UAV is wirelessly recharged by the first road vehicle, and the first UAV and a plurality of other UAVs traveling in the first direction are configured for forming a charging chain to connect with the first road vehicle for charging at least one battery from the first UAV and the plurality of other UAVs.

In some embodiments, process 600 may include the feature of receiving instructions for the first UAV to take off upon the direction of the first road vehicle moving in a different direction than the first direction; and identifying a second road vehicle traveling in the first direction to land on.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

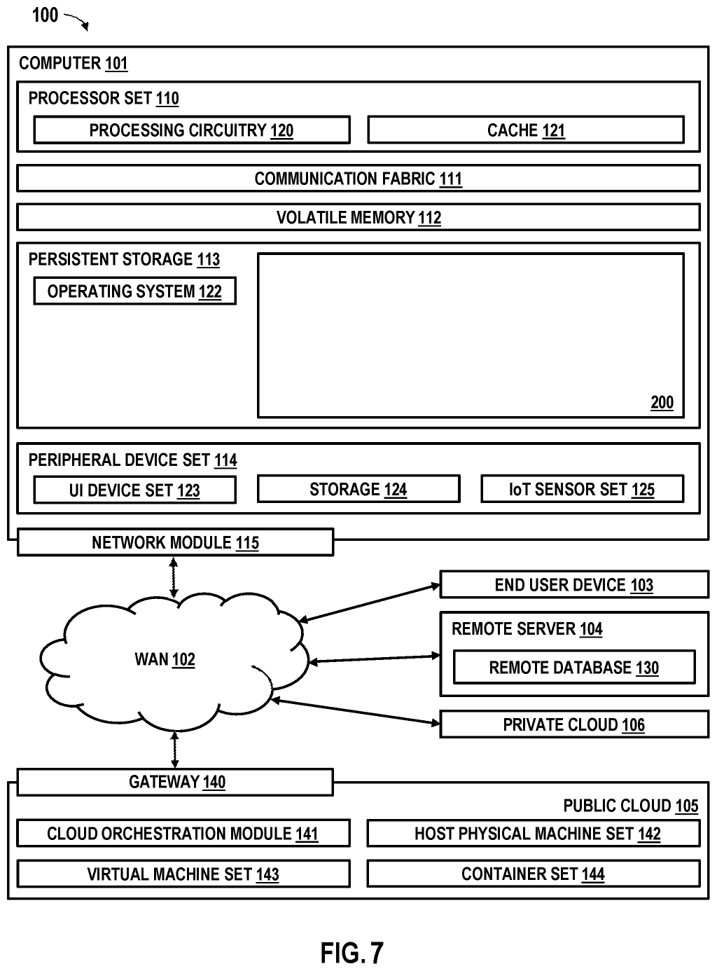

FIG. 7 illustrates an example computing environment 100 utilized by one or more embodiments. Computing environment 100 contains an example of an environment for the execution of at least some of the computer code (block) 200 involved in performing the inventive methods (such as drone (or UAV) blockchain code, drone delivery system communication code, identification of drone service needs code, identification of drone locations and traveling direction code, identification of drone service time delay code, etc.). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated.

What is claimed is:

1. A method of using a computing device to provide unmanned aerial vehicle on road service, the method comprising:
identifying, by the computing device, a first unmanned aerial vehicle (UAV), traveling in a first direction, in need of service that requires down time for the first UAV less than a first threshold;
identifying, by the computing device, a first road vehicle traveling in the first direction and having a landing area with an accommodation size for the first UAV and a second UAV;
upon landing of the first UAV on the first road vehicle, sending, by the computing device, a service request notification to UAV service providers;
landing the second UAV on the first road vehicle next to the first UAV; and
providing the service for the first UAV by the second UAV.

2. The method of claim 1, wherein blockchain technology is utilized for wireless charging of the first UAV and other UAVs and for collaboration of information based on wireless communication.

3. The method of claim 1, wherein the first UAV is a delivery UAV, and the second UAV is a service UAV for servicing the first UAV.

4. The method of claim 1, wherein the second UAV comprises at least one robotic arm and a storage chamber for spare UAV parts.

5. The method of claim 4, wherein the second UAV is configured for replacement of first UAV parts that are in need of service by using the robotic arm.

6. The method of claim 1, wherein the first threshold is a delay time threshold, the first UAV is wirelessly recharged by the first road vehicle, and the first UAV and a plurality of other UAVs traveling in the first direction are configured for forming a charging chain to connect with the first road vehicle for charging at least one battery from the first UAV and the plurality of other UAVs.

7. The method of claim 1, further comprising:
receiving instructions for the first UAV to take off upon the direction of the first road vehicle moving in a different direction than the first direction; and
identifying a second road vehicle traveling in the first direction to land on.

8. A computer program product for providing unmanned aerial vehicle on road service, the computer program product comprising a computer readable storage medium having program instructions embodied therewith, the program instructions executable by a processor to cause the processor to:
identify, by the processor, a first unmanned aerial vehicle (UAV), traveling in a first direction, in need of service that requires down time for the first UAV less than a first threshold;
identify, by the processor, a first road vehicle traveling in the first direction and having a landing area with an accommodation size for the first UAV and a second UAV;
upon landing of the first UAV on the first road vehicle, send, by the processor, a service request notification to UAV service providers;
land the second UAV on the first road vehicle next to the first UAV; and
provide the service for the first UAV by the second UAV.

9. The computer program product of claim 8, wherein blockchain technology is utilized for wireless charging of the first UAV and other UAVs and for collaboration of information based on wireless communication.

10. The computer program product of claim 8, wherein the first UAV is a delivery UAV, and the second UAV is a service UAV for servicing the first UAV.

11. The computer program product of claim 8, wherein the second UAV comprises at least one robotic arm and a storage chamber for spare UAV parts.

12. The computer program product of claim 11, wherein the second UAV is configured for replacement of first UAV parts that are in need of service by using the robotic arm.

13. The computer program product of claim 8, wherein the first threshold is a delay time threshold, the first UAV is wirelessly recharged by the first road vehicle, and the first UAV and a plurality of other UAVs traveling in the first direction are configured for forming a charging chain to connect with the first road vehicle for charging at least one battery from the first UAV and the plurality of other UAVs.

14. The computer program product of claim 8, wherein the program instructions executable by the processor further cause the processor to:
receive, by the processor, instructions for the first UAV to take off upon the direction of the first road vehicle moving in a different direction than the first direction; and
identify, by the processor, a second road vehicle traveling in the first direction to land on.

15. An apparatus comprising:
a memory configured to store instructions; and
a processor configured to execute the instructions to:
identify a first unmanned aerial vehicle (UAV), traveling in a first direction, in need of service that requires down time for the first UAV less than a first threshold;
identify a first road vehicle traveling in the first direction and having a landing area with an accommodation size for the first UAV and a second UAV;
upon landing of the first UAV on the first road vehicle, send a service request notification to UAV service providers;
land the second UAV on the first road vehicle next to the first UAV; and
provide the service for the first UAV by the second UAV.

16. The apparatus of claim 15, wherein blockchain technology is utilized for wireless charging of the first UAV and other UAVs and for collaboration of information based on wireless communication.

17. The apparatus of claim 15, wherein the first UAV is a delivery UAV, and the second UAV is a service UAV for servicing the first UAV.

18. The apparatus of claim 15, wherein the second UAV comprises at least one robotic arm and a storage chamber for spare UAV parts, and the second UAV is configured for replacement of first UAV parts that are in need of service by using the robotic arm.

19. The apparatus of claim 15, wherein the first threshold is a delay time threshold, the first UAV is wirelessly recharged by the first road vehicle, and the first UAV and a plurality of other UAVs traveling in the first direction are configured for forming a charging chain to connect with the first road vehicle for charging at least one battery from the first UAV and the plurality of other UAVs.

20. The apparatus of claim 19, wherein the processor is further configured to execute the instructions to:
receive instructions for the first UAV to take off upon the direction of the first road vehicle moving in a different direction than the first direction; and
identify a second road vehicle traveling in the first direction to land on.
